(19) United States
(12) Patent Application Publication
(10) Pub. No.: US 2006/0091234 A1
(43) Pub. Date: May 4, 2006

(54) Portable misting system

(76) Inventor: James J. Wallander, Coppell, TX (US)

Correspondence Address: RUBEN C. DELEON;WINSTEAD SECHROST & MINICK P.C., P.O. BOX 50784, DALLAS, TX, 75201, US

(21) Appl. No.: 11/264,551

(22) Filed: Nov. 1, 2005

Related U.S. Application Data
(60) Provisional application No. 60/623,914, filed on Nov. 1, 2004.

(51) Int. Cl. A01G 25/09

(52) U.S. Cl. 239/146; 239/147

(57) ABSTRACT

A portable misting system for cooling air, a portable misting apparatus and a method of cooling the air within a portable structure are disclosed. The portable misting system comprises a fluid supply, a tubular conveyance means releasably connected to the fluid supply, one or more fluid to mist conversion/dispersion nozzles attached to the tubular fluid conveyance means, and a portable structure housing the fluid supply, the tubular fluid conveyance means, and the one or more fluid to mist conversion/dispersion nozzles. The portable misting apparatus comprises a fluid supply, a tubular conveyance means releasably connected to the fluid supply, one or more fluid to mist conversion/dispersion nozzles attached to the tubular fluid conveyance means, and a support frame for supporting the portable misting system. The method of cooling the air within a portable structure is the method for using the portable misting apparatus.

### CROSS REFERENCE

This application claims the benefit of U.S. Provisional Application No. 60/623,914, filed on Nov. 1, 2004.

### STATEMENT OF FEDERALLY SPONSORED RESEARCH/DEVELOPMENT

This application is not federally sponsored research/development.

### REFERENCES TO SEQUENCE LISTING

This application is not referenced to any microfiche appendix.

### BACKGROUND OF THE INVENTION

To address the need for cooling in open areas, fine mists of water have been used and released into the air substantially with an area to be cooled. The fine mist evaporates and provides a cooling of the air (evaporative cooling), thereby providing some measure of relief for individuals within the subject area. The fine mist is created by passing a liquid through a carrying tube and exiting through a nozzle such as the Cloudburst product manufactured by Mist & Cool, 1842 Washington Way, Suite B, Venice, Calif. 90291-4704. These systems, however, are not substantially portable in that they are used to provide cooling for a party, wedding reception, etc. that involve many people. Consequently, the pumping mechanisms are large and require electrical connection to 110-volt AC line power and the cooling system cannot be readily moved.

Misting systems are prevalent in the prior art. For instance, U.S. Pat. No. 3,583,147 purports to disclose and claim an evaporative air-cooling apparatus particularly adapted for vehicle cabs, which include a tank for water to be evaporated by a cylindrical porous pad and then pumped to a self-operated circulating nozzle. Air to the vehicle cab is being drawn through the pad and into the cab along a conduit in a heat-exchanging relationship to the water supply.

U.S. Pat. No. 5,613,371 purports to disclose and claim a method and apparatus for misting vehicle occupants. A golf cart or other open-air vehicle is equipped with an apparatus for providing a fine spray of water into the air inside and surrounding the vehicle, resulting in evaporative cooling for the occupants. A pumping system forces water from a water reservoir on-board the vehicle through mister nozzles. The pumping system uses a water filter, pump, and accumulator to achieve a steady spray. In the preferred embodiment, a pressure switch in the golf cart seat turns on the spray when an occupant is sitting in the cart, and stops misting when the occupant is not seated. Alternatively, the misters may be switched to spray continuously or turned off.

U.S. Pat. No. 3,738,621 purports to disclose and claim a rooftop evaporative cooler for cooling the interior of vehicles, such as campers and trailers, whether the vehicle is moving or stationary. The unit includes a rear-facing streamlined housing disposed over a rooftop register. The forward surface of the housing slopes upwardly from the vehicle roof to a horizontal rear portion adjacent a rear-opening, louvered entrance port. A suction fan is disposed with the housing between the entrance port and the register for pulling air into the housing through an evaporative pad and for expelling cooled air, guided by the configuration of the housing, through the register into the vehicle. The cooling medium is pumped from a supply tank contained within the housing to a distributor over the pad and collected after it passes through the pad for recirculation. The supply tank is substantially toroidal and is disposed within the lower portion of the housing, surrounding the rooftop register. The pad is constructed of a suitable porous material and the cooling medium is typically water.

U.S. Pat. No. 4,360,368 purports to disclose and claim the sealed, compact air-conditioner employs the evaporation of water and permits the lowering of the ambient temperature in cabs of machines or vehicles with no compressor or refrigerating circuit being required. The invention comprises a turbo-fan unit directly mounted against an evaporation chamber. Inside the latter, a box facing the air inlets conditions the air distributed toward water injection nozzles and ensures the seal on the upstream side of the chamber. On the opposite side, the outlet for the humidified fresh air is disposed in the upper part and is preceded by a droplet-separating medium. The evaporation chamber, associated with the deflector, constitutes a water recovery pan and is continuously drained by a drain located in the lowermost point thereof. The air-conditioner may be employed for the air-conditioning of agricultural, public works, handling, or cross-country machines or vehicles, such as tractors, harvester-threshers, shovelors or loaders.

U.S. Pat. No. Des. 294,636 purports to disclose and claim an ornamental design for an evaporative cooler.

U.S. Pat. No. 5,285,654 purports to disclose and claim an evaporative cooling system for mounting on the roof of a vehicle in which the sole source of water supply for the evaporative media in the system is contained in a low-profile housing mounted above the roofline of the vehicle.

With respect to golf related activities, cooling devices have been devised, utilized and known to consist of familiar, expected and obvious structural configurations. Prior art however, appears totally devoid of any portable misting system, which would allow maneuverability of a misting system between a plurality of golf course/golf range locations. In so doing, the instant invention enhances the art by allowing golfers to hit or drive golf balls from a natural turf surface. This ability is a direct consequence of the mobility of the instant invention as it allows for continuing growth of grass, turf and other structures typically encountered within the golf course environment. This huge benefit of the instant invention is in stark contrast to those utilized on driving ranges commonly found today which relegate golfers to hit golf balls from artificial turf surfaces.

Consequently, there is a need in the art for a portable, easy to install, versatile, and inexpensive evaporative cooling system, with the system adaptable to a variety of AC or, potentially DC applications to cool individuals engaged in outdoor sporting activities.

In these respects, the adaptable and portable cooling apparatus according to the present invention substantially departs from the conventional concepts and designs of the prior art, and in so doing provides an apparatus developed for purposes of cooling golfers practicing at golfing ranges as well as other individuals engaged in other outdoor sporting activities, while allowing continued growth of grass, turf and other surfaces.

### BRIEF SUMMARY OF THE INVENTION

In view of the foregoing disadvantages inherent in the known types of cooling devices now present in the prior art, the present invention provides a new cooling apparatus construction wherein the same can be utilized for cooling golfers at a driving range, baseball batting cages or other similarly situated environmental surroundings.

The present invention includes a portable, liquid based cooling system that operates on an alternating current (AC) or a direct current (DC) power source. The system also includes tubing and/or pipes to carry a pumped liquid to nozzles coupled to the tubing or pipes to release the liquid into the air in a fine mist. The liquid mist evaporates and cools the air, thereby providing an inexpensive and intentionally transportable cooling system.

According to one aspect of the present invention, the tubing that carries liquid from a liquid source, such as a municipal or private water line (connection) to a nozzle can be a rigid or flexible, insulative tubing that allows a user to configure the tubing to easily accommodate the cooling system to various applications. In addition, the nozzles may be adjustable to alter the mist droplet size exuded by the nozzle or its misting area, thereby allowing a user a substantial amount of flexibility to alter the cooling to one's personal taste. The nozzles are strategically located about predetermined positions in the front, rear, or side portions of the apparatus and release a fine liquid mist into the air. The liquid then evaporates as it travels in the air and causes the air to cool at a region about a golfer on the driving range or other similar structure.

According to another aspect of the present invention, an air-conditioned driving range is disclosed, wherein the range includes a portable, liquid based (such as water) cooling system. The cooling system may optionally include an insulative storage tank for the preferably cool liquid and a pump for pumping the liquid through one or more tubes having nozzles.

According to yet another aspect of the present invention, the cooling system includes a pump or other water supply means, which provides fluid to the one or more nozzles in a substantially non-pulsating manner.

According to another embodiment of the present invention, the pump operates in a substantially non-pulsating mode by use of a bypass valve associated with the pump. The bypass valve operates to pass fluid from the pump inlet to the pump outlet when the outlet pressure increases above a predetermined level, thus maintaining the outlet fluid pressure relatively constant.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative of but a few of the various ways in which the principles of the invention may be employed. Other objects, advantages and novel features of the invention will become apparent from the following detailed description of the invention when considered in conjunction with the drawings.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new portable cooling apparatus and method which has many of the advantages of prior art cooling devices represented and otherwise disclosed in the art and many novel features that result in a new cooling apparatus which is not anticipated, rendered obvious, suggested, or even implied by any of the prior art cooling devices, either alone or in any combination thereof.

It is another object of the present invention to provide a new cooling apparatus, which may be easily and efficiently manufactured and marketed.

It is a further object of the present invention to provide a new cooling apparatus, which is of a durable and reliable construction.

An even further object of the present invention is to provide a new cooling apparatus which is susceptible of a low cost of manufacture with regard to both materials and labor, and which accordingly is then susceptible of low prices of sale to the consuming public, thereby making such personal, portable cooling apparatus economically available to the buying public.

Still yet another object of the present invention is to provide a new cooling apparatus which provides in the apparatuses and methods of the prior art some of the advantages thereof, while simultaneously overcoming some of the disadvantages normally associated therewith.

Yet another object of the present invention is to provide a new cooling apparatus for cooling individuals engaged in golf or baseball practice activities.

Still yet, another object of the present invention is to provide a new cooling apparatus that utilizes a mist of liquid to cool an individual without saturating one's clothes.

Even still, another object of the present invention is to provide a new cooling apparatus that allows individuals to engage in golfing or batting practice activities in warm temperatures more comfortably. The present invention enables individuals, such as the elderly and the young, who are often times susceptible to illness due to the heat to engage in certain outdoor activities during warm weather.

Yet another object of the instant invention is to provide a portable misting system where its portability allows a terrestrial surface to be exposed to sun and moisture and thus precipitate the growth of natural occurring elements typically encountered within a golf course environment.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### DETAILED DESCRIPTION OF THE INVENTION

The present invention will now be described with reference to the drawings wherein like reference numerals are used to refer to like elements throughout.

The present invention will now be described with reference to the drawings wherein like reference numerals are used to refer to like elements throughout.

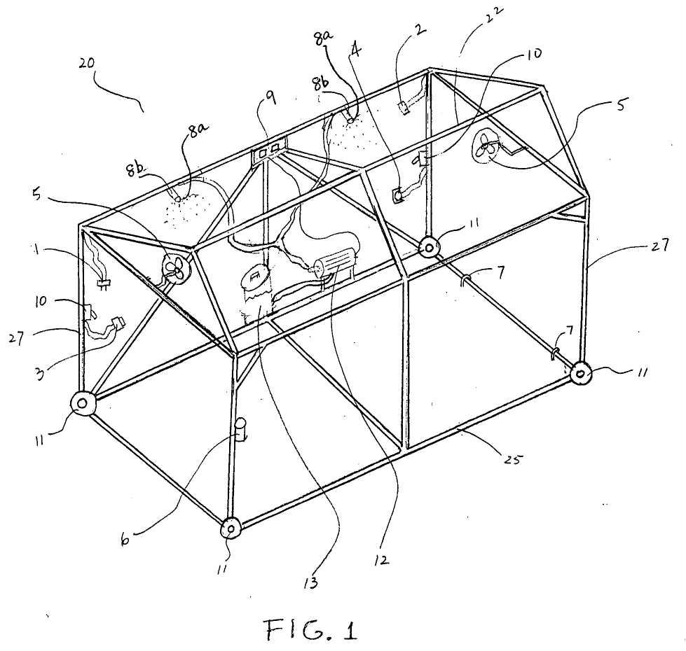

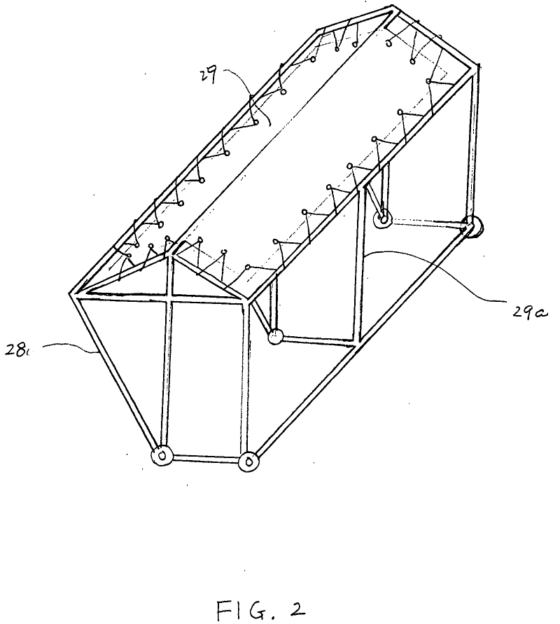

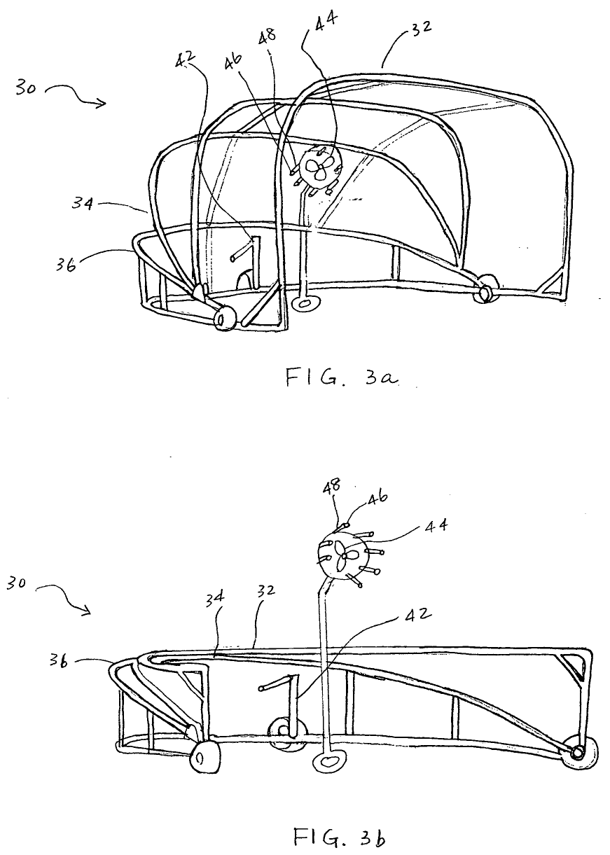

In reference to FIG. 1, a perspective view of one embodiment of the present invention is presented. As can be seen in FIG. 1, the present invention is generally identified as a portable misting system 20. The portable misting system 20 is comprised of a framed structure having interconnecting top 22, bottom 25, and side portions 27. As shown in the embodiment of FIG. 1, the top portion 22 generally constitutes a pitched-like surface, wherein once covered with canvas or other suitable material (e.g., see reference numeral 29 in FIG. 2), inclement weather such as rain and/or snow would be urged to descend the inclined portions alleviating any stress upon the structural framework (22, 25, 27) and associated structures of the portable misting system 20. The top portion 22 covering (not shown in FIG. 1, see FIG. 2) may be comprised of material such as canvas, metal or other similarly intended structure and may be lashed, bolted to or otherwise connected to one or more members of the frame structure (22, 25, 27) of the portable misting system 20. Example of such lashing will be discussed in detail and provided in association with FIGS. 2, 3a, and 3b.

The frame structure 22, 25, 27 of the instant invention may be constructed from and comprised of metal, polyurethane, wood or other similarly intended materials necessary to define and support the structure as described herein. The frame structure (22, 25, and 27) further plays an integral role and constitutes an attachment conveyance by which male electrical plugs and wire 1, female electrical plugs and wire 2, quick disconnect wire inlets 3, quick disconnect water outlet 4, a 120 Volt AC fan 5, a cup-holder 6, section connector clips 7, misting nozzles 8a and supply pipes 8b, an electrical terminal box 9, fan mister on/off switches 10 which may be positioned thereon or placed near or within the enclosed driving station area, and attached wheels 11, which enable the ready transitioning of the portable misting system 20 between any number of physical locations.

The present invention relies upon connection to a readily available water supply and is facilitated by direct connection of the quick disconnect water inlet 4 described above. For purposes of full and enabling disclosure, the structural elements associated with the frame structure of the above-noted invention and location thereof are provided for purposes of example only. The present invention allows for versatile structural element placement and is not to be construed as limited to the positioning posture as defined herein.

As mentioned, the portable misting system 20 includes a plurality of nozzles 8a that are preferably adjustable or replaceable to allow a golfer or other individual to alter the direction in which a liquid mist is released and/or alter the liquid mist droplet size. Such capability provides substantial flexibility to an individual to account for wind, humidity one's personal subjective tastes, and to also vary the emission area (a narrow mist stream or a wide mist stream).

Although depicted in one position of the structure, the nozzles 8a may be positioned in the front, sides or rear of the enclosed driving station area. In such case, a tube or tubes 8b may be run above, under the bottom, or along the side of the enclosed driving station area without substantially interfering with operational or aesthetic aspects of the range. When the system 20 is operational, fluid (e.g., water or other suitable fluid) traverses the system's tubing 8b and enters into one or more nozzles 8a. The nozzles 8a convert the liquid into a fine mist, which provides an evaporative cooling effect. The nozzles 8a are preferably removable to allow for easy replacement or nozzle cleaning. A person of the ordinary skill of art will understand, the nozzles 8a may be secured or locked into place via any known attachment and/or locking mechanism.

An optional pump 12, if utilized, is preferably a 110 or 220-volt portable water pump 12 that is operable to pump the liquid from a container 13 to the nozzles 8a at a pressure of about 40 PSI or greater. More preferably, the pump 12 is sufficiently high-powered to pump the fluid at about 60 PSI. The pump 12 receives the fluid from the tube at an inlet port (not shown) containing a filtering means and pumps the fluid into an output tube at an outlet port. The system of the present invention also provides a means by which alternating current (AC) and/or direct current (DC) power is provided via electrical wires and connectors, which can be secured to the frame structure.

As shown in FIG. 1a, section connector clip 7 is used to facilitate the attachment of one or more additional framed structures such as might be required in the instance of structuring a contiguous line of golf range driving stations or foosball batting zones. Depending on need one, two or more of these structures may be connected to allow for variably located connection engagements of quick disconnect water and electrical outlet positions. The dimensions of the embodiment of the invention shown in FIG. 1 without limitation are about 8 feet in depth, 10 feet in length comprising two driving stations 9 to 10 feet in height.

In reference now to FIG. 2, an alternative embodiment of the instant invention is shown where as opposed to the roughly rectangular sided embodiment designated in FIG. 1, FIG. 2 provides for sides/ends to have an angled orientation 28 thereby providing for enhanced viewing opportunity for a golfer or other practicing participant nearby. It is envisioned by the one embodiment of the invention, as shown in FIG. 2, that the dimensions are between about 8 to 15 feet in depth, about 16 feet in length and about 9 to 12 feet in height. As shown in FIG. 2, the top portion covering 29 may be comprised of material such as canvas, metal or other similarly intended structure and may be lashed, bolted to or otherwise connected to one or more members of the frame structure 29a.

FIGS. 3a and 3b together illustrate an alternative embodiment of the instant invention. FIGS. 3a and 3b provide for a collapsible portable misting system 30 where the top side 32 and a substantial portion of a back side 34 of the portable structure 30 can be retracted down to the base frame 36 as shown in FIG. 3b, and extended fully to the upright position which provides a tent-like covered structure as shown in FIG. 3a. A handle 42 is installed on the base frame 36 to facilitate the movement of the portable structure 30. An AC or DC powered fan 44 is placed inside the portable structure 30. One or more misting nozzles 46 and pipes 48 are installed on or adjacent to the fan 44. The fan 44, the misting nozzles 46 and pipes 48 are designed substantially the same as the embodiments in FIG. 1 and FIG. 2 so as to fulfill the goals of the present invention. A person in the ordinary skill in the art will understand that the fan 44, the misting nozzles 46 and pipes 48 can be removably attached to the portable structure as shown in FIG. 1. In addition, the fan 44, the misting nozzles 46 and pipes 48 can also function separately and without being attached to the portable structure 30 as shown in FIG. 1.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired.

It is therefore, contemplated that the claims will cover any such modifications or embodiments that fall within the true scope of the invention.

1. A portable misting system for cooling air, the system comprising:
a fluid supply;
a tubular fluid conveyance means releasably connected to the fluid supply;
one or more fluid-to-mist conversion/dispersion nozzles attached to the tubular fluid conveyance means; and
a portable structure for housing the fluid supply, the tubular fluid conveyance means, and the one or more fluid to mist conversion/dispersion nozzles.

2. The portable misting system of claim 1 wherein the tubular fluid conveyance means, and the one or more fluid to mist conversion/dispersion nozzles are releasably attached to the portable structure.

3. The portable misting system of claim 1 wherein the portable structure is a rectangular shaped housing structure having a top portion, a back portion, a bottom portion and a plurality of wheels connected to the bottom portion to facilitate movement of the portable structure from one physical location to another.

4. The portable misting system of claim 3 wherein the rectangular shaped housing structure comprises an angled oriented front side wherein the top portion of the housing structure is extended forward.

5. The portable misting system of claim 3 wherein the top portion of the portable structure has a covering lashed, bolted, or otherwise connected to the portable structure.

6. The portable misting system of claim 5 wherein the covering is selected from the group consisting of canvas, plastic, and other water proof materials.

7. The portable misting system of claim 1 wherein the portable structure is a collapsible housing structure having a base frame and a retractable top portion.

8. The portable misting system of claim 7 wherein the retractable top portion having a covering lashed, bolted, or otherwise connected to the collapsible housing structure.

9. The portable misting system of claim 8 wherein the covering is selected from the group consisting of canvas, plastic, and other water prove materials.

10. The portable misting system of claim 1 wherein the portable structure is constructed from material selected from the group consisting of metal, polyurethane, and wood.

11. The portable misting system of claim 1 further comprising at least one male electrical plug and wire, one female electrical plug and wire, one quick disconnect wire inlet, one quick disconnect water outlet, one section connector clip, and one electrical terminal box.

12. The portable misting system of claim 1 further comprising at least one AC or DC driven fan and at least one fan on/off switch.

13. The portable misting system of claim 1 wherein the fluid supply is a portable fluid container.

14. The portable misting system of claim 13 further comprising at least one fluid pump connected to the portable fluid container whereby the fluid pump drives fluid within the portable fluid container to the fluid-to-mist conversion/dispersion nozzles for dispersing mist thereabout a region of the structure.

15. The portable misting system of claim 14 wherein the fluid pump is a 110 or 220-volt pump providing at least about 40 PSI, preferably about 60 PSI.

16. A portable misting apparatus for cooling air within a portable structure, the portable misting system comprising:
a fluid supply;
a tubular fluid conveyance means releasably connected to the fluid supply;
one or more fluid to mist conversion/dispersion nozzles attached to the tubular fluid conveyance means; and
a support frame for supporting the portable misting system.

17. The portable misting apparatus of claim 16 wherein the support frame is connected to wheels in a manner to facilitate movement of the portable structure from one physical location to another.

18. The portable misting apparatus of claim 16 wherein the portable misting system is releasably attached to the portable structure.

19. he portable misting apparatus of claim 16 wherein the portable misting system is placed inside the portable structure.

20. The portable misting apparatus of claim 18 wherein the fan is an AC or DC driven fan.

21. The portable misting apparatus of claim 18 wherein the fluid supply is a portable fluid container.

22. The portable misting apparatus of claim 21 further comprising at least one fluid pump connected to the portable fluid container whereby the fluid pump drives fluid within the portable fluid container to the fluid-to-mist conversion/dispersion nozzles for dispersing mist thereabout a region or the structure.

23. The portable misting apparatus of claim 22 wherein the fluid pump is a 110 or 220-volt pump providing at least about 40 PSI, preferably about 60 PSI.

24. A method of cooling air within a portable structure comprising the steps of:
providing a fluid supply;
providing a tubular fluid conveyance means;
providing one or more fluid-to-mist conversion/dispersion nozzles;
releasably connecting the tubular conveyance means to the fluid supply; and
attaching the tubular conveyance means to the fluid-to-mist conversion/dispersion nozzles.

25. The method of claim 24 further comprising:
providing a support frame; and
releasably attaching the tubular fluid conveyance means and the fluid to mist conversion/dispersion nozzles to the support frame.

26. The method of claim 25 wherein the support frame is connected to wheels in a manner to facilitate movement of the portable structure from one physical location to another.

27. The method of claim 24 further providing at least one fan connecting to the frame to facilitate distribution of the mist dispersed by the fluid-to-mist conversion/dispersion nozzles.

28. The method of claim 27 wherein the fan is an AC or DC driven fan.

29. The method of claim 24 wherein the fluid supply is a portable fluid container.

30. The method of claim 29 further providing at least one fluid pump connected to the portable fluid container whereby the fluid pump drives fluid within the portable fluid container to the fluid-to-mist conversion/dispersion nozzles for dispersing mists.

31. The method of claim 30 wherein the fluid pump is a 110 or 220 volt pump providing at least about 40 PSI, about 60 PSI

32. The system in claim 1 wherein the tubular fluid conveyance means and the fluid to mist conversion/dispersion nozzles are implemented by a portable evaporative cooling unit wherein the portable evaporative cooling unit comprises a housing, a motor, a connection device, and a fan evaporation system.

33. The system in claim 1 wherein the fluid supply is a water source connected to the portable evaporative cooling unit by the connection device.

34. The apparatus of claim 16 wherein the tubular fluid conveyance means and the fluid to mist conversion/dispersion nozzles are implemented by a portable evaporative cooling unit wherein the portable evaporative cooling unit comprises a housing, a motor, a connection device, and a fan evaporation system.

35. The apparatus of claim 16 wherein the fluid supply is a water source connected to the portable evaporative cooling unit by the connection device.

36. The method of claim 24 wherein the tubular fluid conveyance means and the fluid to mist conversion/dispersion nozzles are implemented by a portable evaporative cooling unit wherein the portable evaporative cooling unit comprises a housing, a motor, a connection device, and a fan operated evaporation system.

37. The method of claim 24 wherein the fluid supply is a water source connected to the portable evaporative cooling unit by the connection device.
